(19) United States
(12) Patent Application Publication
(10) Pub. No.: US 2025/0140093 A1
(43) Pub. Date: May 1, 2025

(54) Systems and Methods of Deterrence Using Intruder Mobile Device

(71) Applicant: Vivint, Inc., Provo, UT (US)

(72) Inventor: Brandon Bunker, Provo, UT (US)

(73) Assignee: Vivint, Inc., Provo, UT (US)

(21) Appl. No.: 18/926,565

(22) Filed: Oct. 25, 2024

Related U.S. Application Data
(60) Provisional application No. 63/594,218, filed on Oct. 30, 2023.

(51) Int. Cl. G08B 15/00; G06V 10/70; G06V 20/52; G08B 13/16; G08B 13/189; H04W 4/14

(52) U.S. Cl. CPC G08B 15/004; G06V 10/70; G06V 20/52; H04W 4/14

(57) ABSTRACT

Systems and method are disclosed for detecting an individual and an identifier of a mobile communication device that may be associated with the individual and for generating a message to be delivered to the mobile communication device. The message may include characteristics of the individual to signal knowledge about and information capture on the individual, which can enhance an overall effectiveness of the message. One or more machine-learning models and/or generative artificial intelligence models may be utilized for detecting the individual, determining characteristics, and/or generating an electronic message.

### CROSS REFERENCE

This application claims priority to U.S. Provisional Patent Application 63/594,218, filed Oct. 30, 2023, and entitled SYSTEMS AND METHODS OF DETERRENCE USING A MOBILE DEVICE, which is incorporated by reference herein in its entirety.

### FIELD

This present application relates to home security and/or automation systems and more particularly relates to intruder detection and/or escalated actions.

### BACKGROUND

An intruder or unknown person at a site can be undesirable because of an increased risk of theft, vandalism, or the like. Important property (personal or real) potentially in harm's way is a cause for concern for an owner of the property, which has prompted development of technologies to deter intruders or other unknown persons from lingering and/or perpetrating harm.

Presently available technologies to deter intruders include motion sensor security lights, alarms, sirens, and the like. These environmental deterrent effects originate from the environment of the site where the intruder or unknown person is accessing, and which is being protected by a security and/or automation system. After repetitions of the same deterrent effects or actions, over time they become predictable and may lose their effectiveness as deterrents.

### BRIEF DESCRIPTION OF THE DRAWINGS

Specific embodiments of the invention are illustrated in the following drawings, which depict only embodiments of the invention and should not therefore be considered to limit its scope.

FIG. 1 illustrates an example environment 100 in which the present systems and methods may be implemented.

FIG. 2 is a diagrammatic view of a building system, according to the present disclosure, to detect an identifier of a mobile communication device associated with a detected individual and provide a message to the mobile communication device.

FIG. 3 is a diagram of an apparatus, according to the present disclosure, to deter an intruder by providing a message to a mobile communication device of the intruder.

FIG. 4 is a method, according to the present disclosure, for deterring an intruder.

### DETAILED DESCRIPTION

Disclosed herein are systems and method for detecting an individual and an identifier of a mobile communication device that may be associated with the individual and for generating a message to be delivered to the mobile communication device. The message may include characteristics of the individual to signal knowledge about and information capture on the individual, which can enhance an overall effectiveness of the message. One or more machine-learning models and/or generative artificial intelligence models may be utilized for detecting the individual, determining characteristics, and/or generating an electronic message.

Aspects of the present invention are described herein with reference to system diagrams, flowchart illustrations, and/or block diagrams of methods, apparatuses, systems, and computer program products according to embodiments of the invention. It will be understood that blocks of the flowchart illustrations and/or block diagrams, and combinations of blocks in the flowchart illustrations and/or block diagrams, can be implemented by computer readable program instructions.

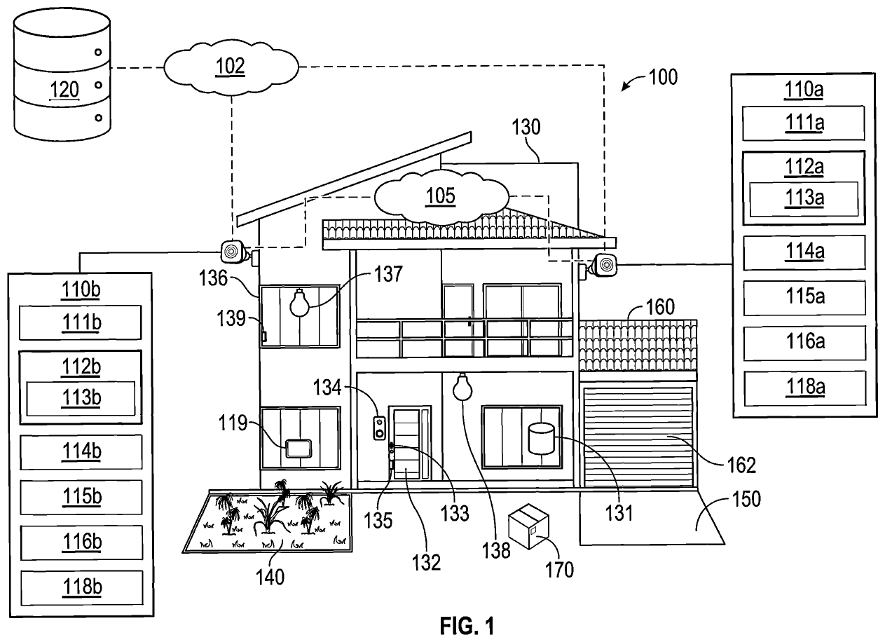

FIG. 1 illustrates an example environment 100 in which the present systems and methods may be implemented. The environment 100 may include a site that can include one or more structures, any of which can be a building 130 such as a home, office, warehouse, garage, and/or the like. The building 130 may include various entryways, such as one or more doors 132, one or more windows 136, and/or a garage 160 having a garage door 162. The environment 100 may include multiple sites. In some implementations, the environment 100 includes multiple sites, each corresponding to a different property or building. In an example, the environment includes a cul-de-sac including multiple homes.

The environment 100 may include a first camera 110a and a second camera 110b, referred to herein collectively as cameras 110. The cameras 110 may be attached to the building 130. The cameras 110 may communicate with each other over a local network 105. The cameras 110 may communicate with a server 120 over a network 102. The local network 105 and/or the network 102, in some implementations, may each include a digital communication network that transmits digital communications. The local network 105 and/or the network 102 may each include a wireless network, such as a wireless cellular network, a local wireless network, such as a Wi-Fi network, a Bluetooth® network, a near-field communication (“NFC”) network, an ad hoc network, and/or the like. The local network 105 and/or the network 102 may each include a wide area network (“WAN”), a storage area network (“SAN”), a local area network (“LAN”) (e.g., a home network), an optical fiber network, the internet, or other digital communication network. The local network 105 and/or the network 102 may each include two or more networks. The network 102 may include one or more servers, routers, switches, and/or other networking equipment. The local network 105 and/or the network 102 may also include one or more computer readable storage media, such as a hard disk drive, an optical drive, non-volatile memory, RAM, or the like.

The local network 105 and/or the network 102 may be a mobile telephone network. The local network 105 and/or the network 102 may employ a Wi-Fi network based on any one of the Institute of Electrical and Electronics Engineers (“IEEE”) 802.11 standards. The local network 105 and/or the network 102 may employ Bluetooth® connectivity and may include one or more Bluetooth connections. The local network 105 and/or the network 102 may employ Radio Frequency Identification (“RFID”) communications, including RFID standards established by the International Organization for Standardization (“ISO”), the International Electrotechnical Commission (“IEC”), the American Society for Testing and Materials® (ASTM®), the DASH7™ Alliance, and/or EPCGlobal™.

In some implementations, the local network 105 and/or the network 102 may employ ZigBee® connectivity based on the IEEE 802 standard and may include one or more ZigBee connections. The local network 105 and/or the network 102 may include a ZigBee® bridge. In some implementations, the local network 105 and/or the network 102 employs Z-Wave® connectivity as designed by Sigma Designs® and may include one or more Z-Wave connections. The local network 105 and/or the network 102 may employ an ANT® and/or ANT+® connectivity as defined by Dynastream® Innovations Inc. of Cochrane, Canada and may include one or more ANT connections and/or ANT+connections.

The first camera 110a may include an image sensor 115a, a processor 111a, a memory 112a, a radar sensor 114a, a speaker 116a, and a microphone 118a. The memory 112a may include computer-readable, non-transitory instructions which, when executed by the processor 111a, cause the processor 111a to perform methods and operations discussed herein. The processor 111a may include one or more processors. The second camera 110b may include an image sensor 115b, a processor 111b, a memory 112b, a radar sensor 114b, a speaker 116b, and a microphone 118b. The memory 112b may include computer-readable, non-transitory instructions which, when executed by the processor 111b, cause the processor to perform methods and operations discussed herein. The processor 111a may include one or more processors.

The memory 112a may include an AI model 113a. The AI model 113a may be applied to or otherwise process data from the camera 110a, the radar sensor 114a, and/or the microphone 118a to detect and/or identify one or more objects (e.g., people, animals, vehicles, shipping packages or other deliveries, or the like), one or more events (e.g., arrivals, departures, weather conditions, crimes, property damage, or the like), and/or other conditions. For example, the cameras 110 may determine a likelihood that an object 170, such as a package, vehicle, person, or animal, is within an area (e.g., a geographic area, a property, a room, a field of view of the first camera 110a, a field of view of the second camera 110b, a field of view of another sensor, or the like) based on data from the first camera 110a, the second camera 110b, and/or other sensors.

The memory 112b of the second camera 110b may include an AI model 113b. The AI model 113b may be similar to the AI model 113a. In some implementations, the AI model 113a and the AI model 113b have the same parameters. In some implementations, the AI model 113a and the AI model 113b may be trained together using data from the cameras 110. In some implementations, the AI model 113a and the AI model 113b may be initially the same, but may be independently trained by the first camera 110a and the second camera 110b, respectively. For example, the first camera 110a may be focused on a porch and the second camera 110b may be focused on a driveway, causing data collected by the first camera 110a and the second camera 110b to be different, leading to different training inputs for the first AI model 113a and the second AI model 113b. In some implementations, the AI models 113 are trained using data from the server 120. In an example, the AI models 113 are trained using data collected from one or more cameras associated with one or more buildings. The cameras 110 may share data with the server 120 for training the AI models 113 and/or one or more other AI models. The AI models 113 may be trained using both data from the server 120 and data from their respective cameras.

The cameras 110, in some implementations, may determine a likelihood that the object 170 (e.g., a package) is within an area (e.g., a portion of a site or of the environment 100). In some embodiments, the identification of the object 170 as being within the area may be based at least in part on audio data from microphones 118, using sound analytics and/or the AI models 113. In some implementations, the cameras 110 may determine a likelihood that the object 170 is within an area based at least in part on image data using image processing, image detection, and/or the AI models 113. The cameras 110 may determine a likelihood that an object is within an area based at least in part on depth (of field) and/or range data from the radar sensors 114, a direct or indirect time of flight sensor, an infrared sensor, a structured light sensor, or other sensor. For example, the cameras 110 may determine a location for an object, a speed of an object, a proximity of an object to another object and/or location, an interaction of an object (e.g., touching and/or approaching another object or location, touching a car/automobile or other vehicle, touching or opening a mailbox, leaving a package, leaving a car door open, leaving a car running, touching a package, picking up a package, or the like), and/or another determination based at least in part on depth data from the radar sensors 114. As used herein, “depth data” may refer to distance from the camera, and/or depth-of-field, giving “depth” to the image data when the radar or depth data are correlated with the image data.

In some embodiments, the area may be defined as a complete field of view of the corresponding camera 110. In other embodiments, the area may be pre-defined as a subsection of the field of view of the corresponding camera 110. The pre-definition of the area may be set as a default. In some embodiments, the area may be selected and/or set. For example, a user may define the area within the field of view of the camera. The user may define the area by dragging boundaries or points within a visual representation of the field of view of the cameras 110, or other sensors. In another embodiments, the user may select areas by clicking, tapping, or otherwise selecting the area generally resulting in an intelligent analysis and selection of the area. In some embodiments, the user may select from one or more pre-determined areas suggested to the user. The user may select and apply or modify a pre-determined area.

In other embodiments, the area may be determined without input from a user. For example, the AI model 113 may analyze the field of view of one or more of the cameras 110 and identify one or more portions of the field of view to designate as one or more areas to monitor. In some embodiments, the AI model 113 may identify the area based on data gathered over time, by an analysis of the field of view of the one or more cameras 110 and/or based on training data corresponding to environments having correlated aspects or characteristics for setting the area.

In some embodiments, the cameras 110 may provide overlapping fields of view. In some example, one or more areas may be defined within an overlapping portion of the fields of view of the cameras 110. One or more other areas may be defined which correspond to a field of view of one of the cameras 110 and not a field of view of another of the cameras 110. In some embodiments, the cameras 110 may generate a composite view of an area corresponding to two or more of the cameras 110. The area may be defined using a field of view of one of the cameras 110 and transposed to at least one other of the cameras 110 containing at least a portion of the defined area.

The environment 100 may include a user interface 119. The user interface 119 may be part of a device, such as a mobile phone, a tablet, a laptop, wall panel, or other device. The user interface 119 may connect to the cameras 110 via the network 102 or the local network 105. The user interface 119 may allow a user to access sensor data of the cameras 110. In an example, the user interface 119 may allow the user to view a field of view of the image sensors 115 and hear audio data from the microphones 118. In an example, the user interface may allow the user to view a representation, such as a point cloud, of radar data from the radar sensors 114.

The user interface 119 may allow a user to provide input to the cameras 110. In an example, the user interface 119 may allow a user to speak or otherwise provide sounds using the speakers 116. One or more sounds may be selected from one or more stored sounds (e.g., stored on memory 112, the server 120, or at another resource or asset. In some embodiments, the user may speak and have the spoken sound communicated directly to one or more speakers 116 associated with one or more of the cameras 110 or separate from the one or more cameras 110.

In some implementations, the cameras 110 may receive additional data from one or more additional sensors, such as a door sensor 135 of the door 132, an electronic lock 133 of the door 132, a doorbell camera 134, and/or a window sensor 139 of the window 136. The door sensor 135, the electronic lock 133, the doorbell camera 134 and/or the window sensor 139 may be connected to the local network 105 and/or the network 102. The cameras 110 may receive the additional data from the door sensor 135, the electronic lock 133, the doorbell camera 134 and/or the window sensor 139 from the server 120.

In some implementations, the cameras 110 may determine separate and/or independent likelihoods that an object is within an area based on data from different sensors (e.g., processing data separately, using separate machine learning and/or other artificial intelligence, using separate metrics, or the like). The cameras 110 may combine data, likelihoods, determinations, or the like from multiple sensors such as image sensors 115, the radar sensors 114, and/or the microphones 118 into a single determination of whether an object is within an area (e.g., in order to perform an action relative to the object 170 within the area. For example, the cameras 110 and/or each of the cameras 110 may use a voting algorithm and/or a weighting protocol and/or other methodology to determine that the object 170 is present within an area in response to a majority of sensors of the cameras and/or of each of the cameras determining that the object 170 is present within the area. In some implementations, the cameras 110 may determine that the object 170 is present within an area in response to all sensors determining that the object 170 is present within the area (e.g., a more conservative and/or less aggressive determination than a voting algorithm). For example, an objection 170 may be confirmed if more sensors agree than disagree or if two or more sensors agree. In some implementations, the cameras 110 may determine that the object 170 is present within an area in response to at least one sensor determining that the object 170 is present within the area (e.g., a less conservative and/or more aggressive determination than a voting algorithm).

The cameras 110, in some implementations, may combine confidence metrics indicating likelihoods that the object 170 is within an area from multiple sensors of the cameras 110 and/or additional sensors (e.g., averaging confidence metrics, selecting a median confidence metric, or the like) in order to determine whether the combination indicates a presence of the object 170 within the area. In some embodiments, the cameras 110 are configured to correlate and/or analyze data from multiple sensors together. For example, the cameras 110 may detect a person or other object in a specific area and/or field of view of the image sensors 115 and may confirm a presence of the person or other object using data from additional sensors of the cameras 110 such as the radar sensors 114 and/or the microphones 118, confirming a sound made by the person or other object, a distance and/or speed of the person or other object, or the like. The cameras 110, in some implementations, may detect the object 170 with one sensor and identify and/or confirm an identity of the object 170 using a different sensor. In an example, the cameras detect the object 170 using the image sensor 115a of the first camera 110a and verifies the object 170 using the radar sensor 114b of the second camera 110b. In this manner, in some implementations, the cameras 110 may detect and/or identify the object 170 more accurately using multiple sensors than may be possible using data from a single sensor.

The cameras 110, in some implementations, in response to determining that a combination of data and/or determinations from the multiple sensors indicates a presence of the object 170 within an area, may perform initiate, or otherwise coordinate one or more actions relative to the object 170 within the area. For example, the cameras 110 may perform an action including emitting one or more sounds from the speakers 116, turning on a light, turning off a light, directing a lighting element toward the object 170, opening or closing the garage door 162, turning a sprinkler on or off, turning a television or other smart device or appliance on or off, activating a smart vacuum cleaner, activating a smart lawnmower, and/or performing another action based on a detected object, based on a determined identity of a detected object, or the like. In an example, the cameras 110 may actuate an interior light 137 of the building 130 and/or an exterior light 138 of the building 130. The interior light 137 and/or the exterior light 138 may be connected to the local network 105 and/or the network 102.

In some embodiments, the cameras 110 may perform initiate, or otherwise coordinate an action selected to deter a detected person (e.g., to deter the person from the area and/or property, to deter the person from damaging property and/or committing a crime, or the like), to deter an animal, or the like. For example, based on a setting and/or mode, in response to failing to identify an identity of a person (e.g., an unknown person, an identity failing to match a profile of an occupant or known user in a library, based on facial recognition, based on bio-identification, or the like), and/or in response to determining a person is engaged in suspicious behavior and/or has performed a suspicious action, or the like, the cameras 110 may perform, initiate, or otherwise coordinate an action to deter the detected person. In some implementations, the cameras 110 may determine that a combination of data and/or determinations from multiple sensors indicates that the detected human is, has, intends to, and/or may otherwise perform one or more suspicious acts, from a set of predefined suspicious acts or the like, such as crawling on the ground, creeping, running away, picking up a package, touching an automobile and/or other vehicle, opening a door of an automobile and/or other vehicle, looking into a window of an automobile and/or other vehicle, opening a mailbox, opening a door, opening a window, throwing an object, or the like.

In some implementations, the cameras 110 may monitor one or more objects based on a combination of data and/or determinations from the multiple sensors. For example, in some embodiments, the cameras 110 may detect and/or determine that a detected human has picked up the object 170 (e.g., a package, a bicycle, a mobile phone or other electronic device, or the like) and is walking or otherwise moving away from the home or other building 101. In a further embodiment, the cameras 110 may monitor a vehicle, such as an automobile, a boat, a bicycle, a motorcycle, an offroad and/or utility vehicle, a recreational vehicle, or the like. The cameras 110, in various embodiments, may determine if a vehicle has been left running, if a door has been left open, when a vehicle arrives and/or leaves, or the like.

The environment 100 may include one or more regions of interest, which each may be a given area within the environment. A region of interest may include the entire environment 100, an entire site within the environment, or an area within the environment. A region of interest may be within a single site or multiple sites. A region of interest may be inside of another region of interest. In an example, a property-scale region of interest which encompasses an entire property within the environment 100 may include multiple additional regions of interest within the property.

The environment 100 may include a first region of interest 140 and/or a second region of interest 150. The first region of interest 140 and the second region of interest 150 may be determined by the AI models 113, fields of view of the image sensors 115 of the cameras 110, fields of view of the radar sensors 114, and/or user input received via the user interface 119. In an example, the first region of interest 140 includes a garden or other landscaping of the building 130 and the second region of interest 150 includes a driveway of the building 130. In some implementations, the first region of interest 140 may be determined by user input received via the user interface 119 indicating that the garden should be a region of interest and the AI models 113 determining where in the fields of view of the sensors of the cameras 110 the garden is located. In some implementations, the first region of interest 140 may be determined by user input selecting, within the fields of view of the sensors of the cameras 110 on the user interface 119, where the garden is located. Similarly, the second region of interest 150 may be determined by user input indicating, on the user interface 119, that the driveway should be a region of interest and the AI models 113 determining where in the fields of view of the sensors of the cameras 110 the driveway is located. In some implementations, the second region of interest 150 may be determined by user input selecting, on the user interface 119, within the fields of view of the sensors of the cameras 110, where the driveway is located.

In response to determining that a combination of data and/or determinations from the multiple sensors indicates that a detected human is, has, intends to, and/or may otherwise perform one or more suspicious acts, is unknown/unrecognized, has entered a restricted area/zone such as the first region of interest 140 or the second region of interest 150, the cameras 110 may expedite a deter action, reduce a waiting/monitoring period after detecting the human and before performing a deter action, or the like. In response to determining that a combination of data and/or determinations from the multiple sensors indicates that a detected human is continuing and/or persisting performance of one or more suspicious acts, the cameras 110 may escalate one or more deter actions, perform one or more additional deter actions (e.g., a more serious deter action), or the like. For example, the cameras 110 may play an escalated and/or more serious sound such as a siren, yelling, or the like; may turn on a spotlight, strobe light, or the like; and/or may perform, initiate, or otherwise coordinate another escalated and/or more serious action. In some embodiments, the cameras 110 may enter a different state (e.g., an armed mode, a security mode, an away mode, or the like) in response to detecting a human in a predefined restricted area/zone or other region of interest, or the like (e.g., passing through a gate and/or door, entering an area/zone previously identified by an authorized user as restricted, entering an area/zone not frequently entered such as a flowerbed, shed or other storage area, or the like).

In a further embodiment, the cameras 110 may perform, initiate, or otherwise coordinate, a welcoming action and/or another predefined action in response to recognizing a known human (e.g., an identity matching a profile of an occupant or known user in a library, based on facial recognition, based on bio-identification, or the like) such as executing a configurable scene for a user, activating lighting, playing music, opening or closing a window covering, turning a fan on or off, locking or unlocking a door 132, lighting a fireplace, powering an electrical outlet, turning on or play a predefined channel or video or music on a television or other device, starting or stopping a kitchen appliance, starting or stopping a sprinkler system, opening or closing a garage door 103, adjusting a temperature or other function of a thermostat or furnace or air conditioning unit, or the like. In response to detecting a presence of a known human, one or more safe behaviors and/or conditions, or the like, in some embodiments, the cameras 110 may extend, increase, pause, toll, and/or otherwise adjust a waiting/monitoring period after detecting a human, before performing a deter action, or the like.

In some implementations, the cameras 110 may receive a notification from a user's smart phone that the user is within a predefined proximity or distance from the home, e.g., on their way home from work. Accordingly, the cameras 110 may activate a predefined or learned comfort setting for the home, including setting a thermostat at a certain temperature, turning on certain lights inside the home, turning on certain lights on the exterior of the home, turning on the television, turning a water heater on, and/or the like.

The cameras 110, in some implementations, may be configured to detect one or more health events based on data from one or more sensors. For example, the cameras 110 may use data from the radar sensors 114 to determine a heartrate, a breathing pattern, or the like and/or to detect a sudden loss of a heartbeat, breathing, or other change in a life sign. The cameras 110 may detect that a human has fallen and/or that another accident has occurred.

In some embodiments, the cameras 110 are configured to play and/or otherwise emit one or more sounds in response to detecting the presence of a human within an area. For example, the cameras 110 may play one or more sounds selected to deter a detected person from an area around a property/building 101 and/or object. The cameras 110, in some implementations, may vary sounds over time, dynamically layer and/or overlap sounds, and/or generate unique sounds, to preserve a deterrent effect of the sounds over time and/or to avoid, limit, or even prevent those being deterred from becoming accustomed to the same sounds used over and over.

The cameras 110, in some implementations, stores and/or has access to a library comprising a plurality of different sounds and/or a set of dynamically generated sounds so that the controller 106 may vary the different sounds over time, not using the same sound often. In some embodiments, varying and/or layering sounds allows a deter sound to be more realistic and/or less predictable. One or more of the sounds may be selected to give a perception of human presence in the building 101, a perception of a human talking over an electronic speaker device, or the like which may be effective at preventing crime and/or property damage.

For example, a library and/or other set of sounds may include audio recordings and/or dynamically generated sounds of one or more, male and/or female voices saying different phrases, such as for example, a female saying “hello?”, a female and male together saying “can we help you?”, a male with a gruff voice saying, “get off my property” and then a female saying “what's going on?”, a female with a country accent saying “hello there”, a dog barking, a teenager saying “don't you know you're on camera?”, and/or a man shouting “hey!” or “hey you!”, or the like.

In some implementations, the cameras 110 may dynamically generate one or more sounds (e.g., using machine learning and/or other artificial intelligence, or the like) with one or more attributes that vary from a previously played sound. For example, the cameras 110 may generate sounds with different verbal tones, verbal emotions, verbal emphases, verbal pitches, verbal cadences, verbal accents, or the like so that the sounds are said in different ways, even if they include some or all of the same words. In some embodiments, the cameras 110 and/or a remote computer 125 may train machine learning on reactions of previously detected humans in other areas to different sounds and/or sound combinations (e.g., improving sound selection and/or generation over time).

The cameras 110 may combine and/or layer these sounds (e.g., primary sounds), with one or more secondary, tertiary, and/or other background sounds, which may comprise background noises selected to give an appearance that a primary sound is a person speaking in real time, or the like. For example, a secondary, tertiary, and/or other background sound may include sounds of a kitchen, of tools being used, of someone working in a garage, of children playing, of a television being on, of music playing, of a dog barking, or the like. The cameras 110, in some embodiments, may be configured to combine and/or layer one or more tertiary sounds with primary and/or secondary sounds for more variety, or the like. For example, a first sound (e.g., a primary sound) may comprise a verbal language message and a second sound (e.g., a secondary and/or tertiary sound) may comprise a background noise for the verbal language message (e.g., selected to provide a real-time temporal impression for the verbal language message of the first sound, or the like).

In this manner, in various embodiments, the cameras 110 may intelligently track which sounds and/or combinations of sounds have been played, and in response to detecting the presence of a human, may select a first sound to play that is different than a previously played sound, may select a second sound to play that is different than the first sound, and may play the first and second sounds at least partially simultaneously and/or overlapping. For example, the cameras 110 may play a primary sound layered and/or overlapping with one or more secondary, tertiary, and/or background sounds, varying the sounds and/or the combination from one or more previously played sounds and/or combinations, or the like.

The cameras 110, in some embodiments, may select and/or customize an action based at least partially on one or more characteristics of a detected object. For example, the cameras 110 may determine one or more characteristics of the object 170 based on audio data, image data, depth data, and/or other data from a sensor. For example, the cameras 110 may determine a characteristic such as a type or color of an article of clothing being worn by a person, a physical characteristic of a person, an item being held by a person, or the like. The cameras 110 may customize an action based on a determined characteristic, such as by including a description of the characteristic in an emitted sound (e.g., “hey you in the blue coat!”, “you with the umbrella!”, or another description), or the like.

The cameras 110, in some implementations, may escalate and/or otherwise adjust an action over time and/or may perform a subsequent action in response to determining (e.g., based on data and/or determinations from one or more sensors, from the multiple sensors, or the like) that the object 170 (e.g., a human, an animal, vehicle, drone, etc.) remains in an area after performing a first action (e.g., after expiration of a timer, or the like). For example, the cameras 110 may increase a volume of a sound, emit a louder and/or more aggressive sound (e.g., a siren, a warning message, an angry or yelling voice, or the like), increase a brightness of a light, introduce a strobe pattern to a light, and/or otherwise escalate an action and/or subsequent action. In some implementations, the cameras 110 may perform a subsequent action (e.g., an escalated and/or adjusted action) relative to the object 170 in response to determining that movement of the object 170 satisfies a movement threshold based on subsequent depth data from the radar sensors 114 (e.g., subsequent depth data indicating the object 170 is moving and/or has moved at least a movement threshold amount closer to the radar sensors 114, closer to the building 130, closer to another identified and/or predefined object, or the like).

In some implementations, the cameras 110 and/or the server 120, may include image processing capabilities and/or radar data processing capabilities for analyzing images, videos, and/or radar data that are captured with the cameras 110. The image/radar processing capabilities may include object detection, facial recognition, gait detection, and/or the like. For example, the controller 106 may analyze or process images and/or radar data to determine that a package is being delivered at the front door/porch. In other examples, the cameras 110 may analyze or process images and/or radar data to detect a child walking within a proximity of a pool, to detect a person within a proximity of a vehicle, to detect a mail delivery person, to detect animals, and/or the like. In some implementations, the cameras 110 may utilize the AI models 113 for processing and analyzing image and/or radar data. For example, the AI models 113 may be trained using training data that may include one or more images of the object to be identified, validation data to validate the operation of the AI models 113, key performance indicators (KPI) or other test/evaluation data to assess the capability of the AI models 113 to identify an object in the field of view of one or more of the cameras 110.

In some implementations, the cameras 110 are connected to various IoT devices. As used herein, an IoT device may be a device that includes computing hardware to connect to a data network and to communicate with other devices to exchange information. In such an embodiment, the cameras 110 may be configured to connect to, control (e.g., send instructions or commands), and/or share information with different IoT devices. Examples of IoT devices may include home appliances (e.g. stoves, dishwashers, washing machines, dryers, refrigerators, microwaves, ovens, coffee makers), vacuums, garage door openers, thermostats, HVAC systems, irrigation/sprinkler controller, television, set-top boxes, grills/barbeques, humidifiers, air purifiers, sound systems, phone systems, smart cars, cameras, projectors, and/or the like. In some implementations, the cameras 110 may poll, request, receive, or the like information from the IoT devices (e.g., status information, health information, power information, and/or the like) and present the information on a display and/or via a mobile application.

The IoT devices may include a smart home device 131. The smart home device 131 may be connected to the IoT devices. The smart home device 131 may receive information from the IoT devices, configure the IoT devices, and/or control the IoT devices. In some implementations, the smart home device 131 provides the cameras 110 with a connection to the IoT devices. In some implementations, the cameras 110 provide the smart home device 131 with a connection to the IoT devices. The smart home device 131 may be an AMAZON ALEXA device, an AMAZON ECHO, A GOOGLE NEST device, a GOOGLE HOME device, or other smart home hub or device. In some implementations, the smart home device 131 may receive commands, such as voice commands, and relay the commands to the cameras 110. In some implementations, the cameras 110 may cause the smart home device 131 to emit sound and/or light, speak words, or otherwise notify a user of one or more conditions via the user interface 119.

In some implementations, the IoT devices include various lighting components including the interior light 137, the exterior light 138, the smart home device 131, other smart light fixtures or bulbs, smart switches, and/or smart outlets. For example, the cameras 110 may be communicatively connected to the interior light 137 and/or the exterior light 138 to turn them on/off, change their settings (e.g., set timers, adjust brightness/dimmer settings, and/or adjust color settings).

In some implementations, the IoT devices include one or more speakers within the building. The speakers may be stand-alone devices such as speakers that are part of a sound system, e.g., a home theatre system, a doorbell chime, a Bluetooth speaker, and/or the like. In some implementations, the one or more speakers may be integrated with other devices such as televisions, lighting components, camera devices (e.g., security cameras that are configured to generate an audible noise or alert), and/or the like. In some implementations, the speakers may be integrated in the smart home device 131.

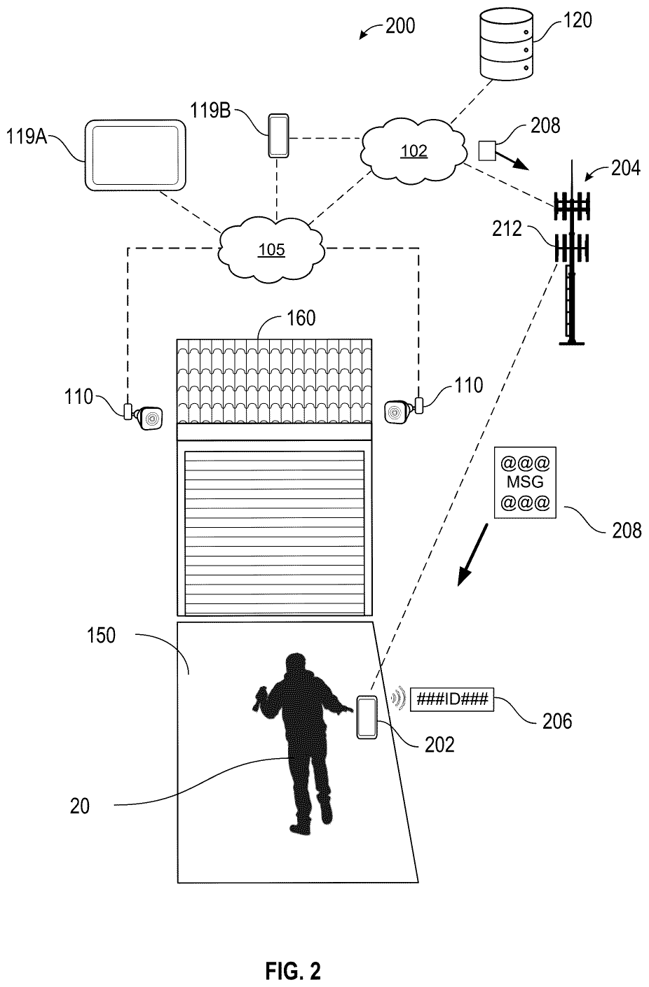

FIG. 2 is a diagrammatic view of a building system 200, according to some embodiments of the present disclosure, to detect an identifier 206 of a mobile communication device 202 associated with a detected individual 20 and provide a message 208 to the mobile communication device 202. FIG. 2 includes a portion of the building of FIG. 1 (e.g., the garage 160) and a region of interest 150 (which in this case is a driveway) for reference. The building system 200 may be a security system and/or a home automation system. The building system 200 includes one or more sensing devices, such as cameras 110.

The cameras 110 may include one or more of an image sensor, a processor, and a memory, as described above with reference to FIG. 1. The cameras 110, may also include additional sensor devices such as a radar sensor, a microphone, an antenna/radio/transceiver, and/or the like. The cameras 110 may communicate with each other over a local network 105. The cameras 110 may communicate with a server 120 or other component or device over a network 102 in wireless, wired, or a combination of wired and wireless communication.

The building system 200 may include one or more apparatuses, such as one of the cameras 110, the server 120, a fixed user interface 119A (e.g., a panel), a portable electronic device 119B, to detect the presence of an individual 20, detect an identifier 206 of a mobile communication device 202 of the individual 20, and generate a message 208 to the mobile communication device 202.

The system 200 may detect a presence of an individual at a site based on sensor data (e.g., first sensor data, which may include, for example, one or more of image data, audio data, and/or depth data) from one or more sensors positioned at the site. The system 200 may detect the presence of an individual by image processing, audio processing, and/or radar processing techniques, algorithms, devices, etc. The system 200 may detect a presence of an individual utilizing a model (e.g., a machine-learning model trained and utilized to detect or otherwise identify an individual).

The system 200 may determine one or more characteristics of a detected individual. Determining the one or more characteristics of the individual may include determining, height, girth, weight, hair color, gait, clothing (e.g., type, style, color), category, profession, identity, and/or other characteristics. For example, the system 200 may determine one or more literal characteristics, such as, but not limited to, a type or color of an article of clothing being worn by the individual, a physical characteristic (e.g., height, size, build) of the individual, an item being held by the individual, a path, trajectory, or direction of travel (e.g., toward the site, away from the site, across the site, etc.) of the individual, a location of the individual at the site, proximity to an area (e.g., flower garden, driveway, etc.) of interest or object (e.g., car, bike, package, etc.) of interest at the site, a status of the individual as a returnee to the site, and/or a status of the individual as a resident of a home at the site. The system 200 may determine the literal characteristics by one or more of image processing and/or audio processing. In some embodiments, the system 200 may determine the literal characteristics utilizing a machine-learning model.

In some embodiments, the system 200 may determine one or more inferred characteristics of the individual, such as, but not limited to, an intent of the individual (e.g., vandalism, theft, loitering, visiting, delivering, servicing (e.g., shoveling, moving, mowing, etc.), etc.) and/or a status of the individual as an intruder or as someone appropriately at the site (e.g., friend, resident). The system 200 may determine the one or more inferred characteristics of the individual based on the literal characteristics. The system may determine the literal characteristics and/or the inferred characteristics utilizing a model, such as a machine learning model, an artificial intelligence model, or the like.

The system 200 may also determine an identifier 206 of a mobile communication device 202 at a location of the individual 20 detected at the site, according to the sensor data (e.g., second sensor data, such as data captured by an antenna, radio, transceiver, etc.). Presently available mobile communication systems have protocols that include a mobile communication device transmitting (e.g., broadcasting) an identifier to a base station 212 (or node) of a mobile communication network 204 to establish and/or maintain a communicative connection with the mobile communication network 204. The identifier is a unique identifier to indicate to the communication network the mobile communication device that is connecting to the communication network. In FIG. 2, the mobile communication device 202 of the individual 20 is transmitting an identifier 206 to establish or maintain a connection to a base station 212 of the mobile communication network 204 (e.g., a cellular carrier). The system 200 can capture or otherwise detect the transmitted identifier 206 to determine an identifier of the mobile communication device 202. The identifier 206 can be any suitable identifier, such as a temporary mobile subscriber identifier (TMSI), a globally unique temporary identifier (GUTI), a subscription concealed identifier (SUCI), a subscription permanent identifier (SUPI), an international mobile subscriber identity (IMSI), and a network access identifier (NAI). The identifier 206 may be temporary, so as to attempt to conceal an actual identity of the individual 20. In other embodiments, the identifier 206 may be a permanent identifier for the mobile device 202 on the mobile communication network 204. In some embodiments, the identifier 206 may be a network identifier on a local network. For example, the mobile communication device 202 may be configured to detect and join a nearby Wi-Fi network, such as the Xfinity® WIFI network provided by Comcast® or similar networks. The identifier 206 may be determined through detecting a new (and potentially unknown) device connecting to a network hotspot. The identifier 206 provides a way for sending a message or for requesting the mobile communication network 204 to send a message to the mobile communication device 202.

The system 200 can generate an electronic message 208 for transmission to the mobile communication device 202. The electronic message 208 can be a text message, such as a short message system (SMS) text message. The electronic message 208 can include image data such as an image of the individual 20. The electronic message 208 can be generated to contain content based on the one or more characteristics. For example, the individual 20 may be wearing a blue shirt and the electronic message 208 can be generated to state, “Hey you, in the blue shirt, you are on my property. Please leave!” As another example, the person may be driving a brown truck and carrying a box and the message 208 can be generated to state, “Hello, delivery person, you can leave that package behind the column on the porch.” The electronic message 208 can be generated to contain content according to the sensor data. For example, the individual 20 may be standing on a driveway near a vehicle in the late hours of the night and the electronic message 208 can be generated to state “Get off my driveway! It is 2:33 am and, if you don't get away from my car, I am going to call the police!” As another example, a homeowner may desire that the system provide a reminder, and the electronic message 208 may be generated to state “Hello, Mr. ______, welcome home from work. Don't forget to pick up the mail while you are at the mailbox.” Stated otherwise, the electronic message 208 can be personalize or otherwise customized according to the characteristics of the individual 20 and/or the sensor data at the time of detection of the presence of the individual 20. The message 208 may be generated to induce an action, such as to have a deterrent effect or a welcoming (or greeting) effect. For example, an electronic message 208 with a deterrent effect may include one or more of a request to leave, a warning or threat (e.g., to call the police), and/or evidence of possession of information about the identity of the individual, a copy of a message provided to law enforcement. As another example, an electronic message 208 with a welcoming effect may include a salutation, evidence of recognition of the individual, etc.

The system 200, after generating the electronic message 208, can transmit the electronic message 208 for delivery to the mobile communication device 202, according to the identifier 206. The system 200 may transmit the electronic message 208 (along with the identifier 206) to the mobile communication network 204, which can then use the identifier 206 to locate the mobile communication device 202 and transmit the electronic message 208 to the mobile communication device 202. In another embodiment, the system 200 may transmit the electronic message 208 via an electronic network 102 (e.g., the Internet) and/or a local electronic network 105, according to the identifier 206. In some embodiments, the system 200 may transmit the electronic message 208 and identifier 206 to a server 120 for subsequent transmission to the mobile communication device 202. In still other embodiments, the system 200 may transmit the message 208 directly to the mobile communication device 202, such as via a wireless protocol (e.g., WiFi, Bluetooth, etc.).

As can be appreciated, the individual 20 receiving an electronic message 208 containing information on the individual's characteristics, location and/or whereabouts in relation to a site and timing may be more effectively deterred, or may feel more emphatically welcomed, by such a customized or personalized message. Thus, the technical solutions described herein can address shortcomings of existing technology that can lose effectiveness over time.

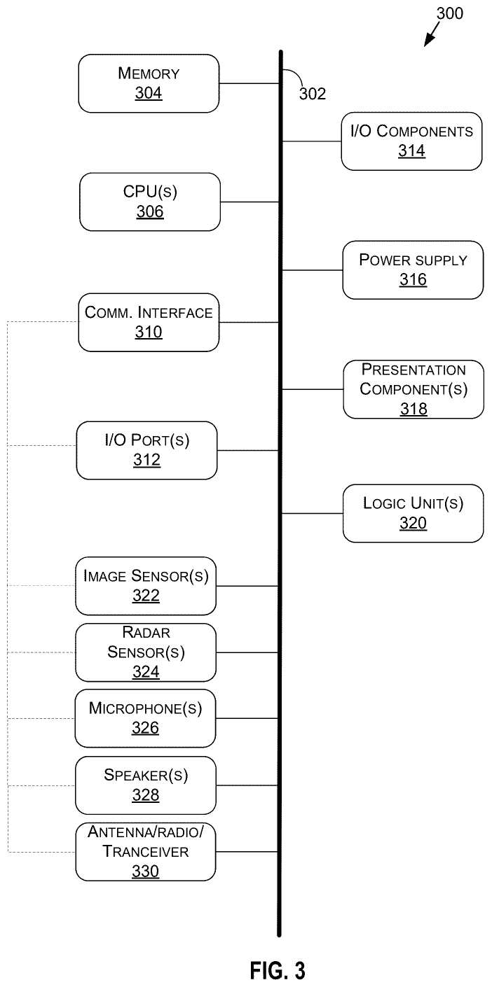

FIG. 3 is a block diagram of an example computing device(s) 300 suitable for use in implementing at least some embodiments of the present disclosure. For example, computing device 300 can provide a hardware component and/or hardware framework for implementing environment 100 from FIG. 1. The computing device 300 may include an interconnect system 302 (e.g., a bus) that directly or indirectly couples one or more of the following devices to another of the following devices: memory 304, one or more central processing units (CPUs) 306 and/or other processing units (e.g., graphics processing unites (GPUs)), a communication interface 310, input/output (I/O) ports 312, input/output components 314, a power supply 316, one or more presentation components 318 (e.g., display(s)), and one or more logic units 320.

In at least one embodiment, the computing device(s) 300 may comprise one or more virtual machines (VMs), or features of a cloud computing system or environment and/or any of the components thereof may comprise virtual components (e.g., virtual hardware components). For non-limiting examples, one or more of the CPUs 306 may comprise one or more vCPUs and/or one or more of the logic units 320 may comprise one or more virtual logic units. As such, a computing device(s) 300 may include discrete components (e.g., a full GPU dedicated to the computing device 300), virtual components (e.g., a portion of a GPU dedicated to the computing device 300), or a combination thereof.

In some embodiments, the interconnect system 302 also directly or indirectly couples one or more of the foregoing devices to one or more of the following devices: image sensor(s) 322, a radar 324 (or other depth of field sensor(s) or range sensor(s)), microphone(s) 326 (or other audio sensor(s)), speaker(s) 328 (or other output device(s)), and/or antenna/radio/transceiver(s) 330. In some embodiments, the comm. interface 310 or the I/O ports 312 may provide direct or indirect coupling to one or more of the image sensor 322, the radar 324, the microphone 326, the speaker 328, and the antenna/radio/transceiver(s) 330.

Although the various blocks of FIG. 3 are shown as connected via the interconnect system 302 with lines, this is not intended to be limiting and is for clarity only. For example, in some embodiments, a presentation component 318, such as a display device, may be considered an I/O component 314 (e.g., if the display is a touch screen). As another example, the CPUs 306 may include memory (e.g., the memory 304 may be representative of a storage device in addition to the memory of the CPUs 306 and/or other components). In other words, the computing device of FIG. 3 is merely illustrative. Distinction is not made between such categories as “workstation,” “server,” “laptop,” “desktop,” “tablet,” “client device,” “mobile device,” “hand-held device,” “electronic control unit (ECU),” “control panel”, “cloud computing environment” and/or other device or system types, as all are contemplated within the scope of the computing device of FIG. 3.

The interconnect system 302 may represent one or more links or busses, such as an address bus, a data bus, a control bus, or a combination thereof. The interconnect system 302 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 306 may be directly connected to the memory 304. Where there is direct, or point-to-point connection between components, the interconnect system 302 may include a PCIe link to carry out the connection. In these examples, a PCI bus need not be included in the computing device 300.

The memory 304 may include any of a variety of computer-readable media. The computer-readable media may be any available media that may be accessed by the computing device 300. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 304 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 300. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 306 may be configured to execute at least some of the computer-readable instructions to control one or more components of the computing device 300 to perform one or more of the methods and/or processes described herein. The CPU(s) 306 may each include one or more cores (e.g., one, two, four, eight, twenty-eight, seventy-two, etc.) that are capable of handling a multitude of software threads simultaneously. The CPU(s) 306 may include any type of processor, and may include different types of processors depending on the type of computing device 300 implemented (e.g., processors with fewer cores for mobile devices and processors with more cores for servers). For example, depending on the type of computing device 300, the processor may be an Advanced RISC Machines (ARM) processor implemented using Reduced Instruction Set Computing (RISC) or an x86 processor implemented using Complex Instruction Set Computing (CISC). The computing device 300 may include one or more CPUs 306 in addition to one or more microprocessors or supplementary co-processors, such as math co-processors.

In addition to or alternatively from the CPU(s) 306, the logic unit(s) 320 may be configured to execute at least some of the computer-readable instructions to control one or more components of the computing device 300 to perform one or more of the methods and/or processes described herein. In embodiments, the CPU(s) 306 and/or the logic unit(s) 320 may discretely or jointly perform any combination of the methods, processes and/or portions thereof. One or more of the logic units 320 may be part of and/or integrated in one or more of the CPU(s) 306 and/or one or more of the logic units 320 may be discrete components or otherwise external to the CPU(s) 306. In embodiments, one or more of the logic units 320 may be a coprocessor of one or more of the CPU(s) 306.

Examples of the logic unit(s) 320 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 310 may include one or more receivers, transmitters, and/or transceivers that enable the computing device 300 to communicate with other computing devices via an electronic communication network, included wired and/or wireless communications. The communication interface 310 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 320 and/or communication interface 310 may include one or more data processing units (DPUs) to transmit data received over a network and/or through interconnect system 302.

The I/O ports 312 may enable the computing device 300 to be logically coupled to other devices including the I/O components 314, the presentation component(s) 318, and/or other components, some of which may be built in to (e.g., integrated in) the computing device 300. Illustrative I/O components 314 include a microphone, mouse, keyboard, joystick, satellite dish, scanner, printer, wireless device, etc. The I/O components 314 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 300.

The power supply 316 may include a hard-wired power supply, a battery power supply, or a combination thereof. The power supply 316 may provide power to the computing device 300 to enable the components of the computing device 300 to operate.

The presentation component(s) 318 may include a display (e.g., a monitor, a touch screen, a television screen, a heads-up-display (HUD), other display types, or a combination thereof), speakers, and/or other presentation components. The presentation component(s) 318 may receive data from other components (e.g., the CPU(s) 306, DPUs, etc.), and output the data (e.g., as an image, video, sound, etc.).

The image sensor(s) 322 may be a camera to capture image data. The computing device 300 may be include depth cameras, such as stereoscopic camera systems, infrared camera systems, RGB camera systems, touchscreen technology, and combinations of these, for gesture detection and recognition.

The radar sensor(s) 324 may provide depth data, as in depth of field data or range data to indicate a distance of objects from the radar sensor(s) and thereby provide additional spatial information for objects detected by the image sensor(s) 322.

The microphone(s) 326 capture sounds in the environment, including sounds of objects, animals, and humans. Any of a clanking, banging, shattering, etc. sound may provide an indicator of vandalism, theft, or other damage. A dog barking may provide indication of an intruder.

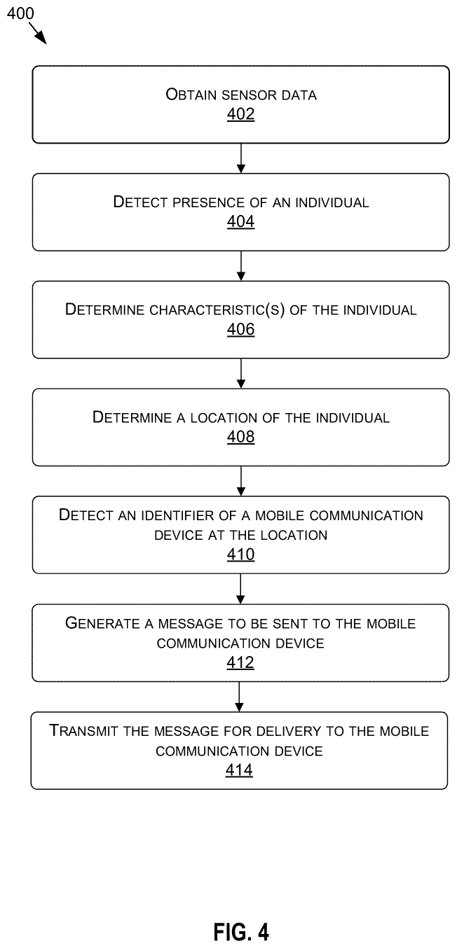

FIG. 4 is a flow diagram 400 of a method, according to the present disclosure, for deterring an intruder. The method can include: obtaining 402 sensor data, detecting 404 a presence of an individual at a site, determining 406 one or more characteristics of the individual, determining 408 a location of the individual at the site, detecting 410 an identifier of a mobile communication device at the location, generating 412 a message to be sent to the mobile communication device, and transmitting 414 the message for delivery to the mobile communication device.

Sensor data can be obtained 402 from one or more sensors at a site. The sensor data can include first sensor data, such as image data, audio data, and/or depth data captured from image sensor(s) (e.g., camera(s)), microphone(s), radar, etc. The sensor data can include second sensor data, such as data captured by an antenna, radio, transceiver, etc. The second sensor data can include a transmission or broadcast of an identifier from a mobile communication device.

A presence of an individual can be detected 404 according to the sensor data, and more particularly the first sensor data, such as image data from a camera, audio data from a microphone, and/or depth data from radar. The presence of an individual can be detected 404 by image processing, audio processing, and/or radar processing techniques, algorithms, devices, processing, etc. The presence of an individual can be detected 404 by a model (e.g., a machine-learning model trained and utilized to detect or otherwise identify an individual). In an example, an individual may be identified, using a machine-learning model executed on a camera, such as on a porch of a house or positioned at an exterior of a house.

One or more characteristics of an individual can be determined 406 according to the sensor data, and more particularly the first sensor data, such as image data from a camera, audio data from a microphone, and/or depth data from radar. Determining 406 the one or more characteristics of the individual may include determining 406 literal characteristics and/or inferred characteristics.

Examples of one or more literal characteristics of an individual can include, but are not limited to, a type or color of an article of clothing being worn by the individual, a physical characteristic (e.g., height, girth, size, build, weight, hair color, gait), a role or task (e.g., mail delivery, package delivery) of the individual, identity of the individual, an item being held by the individual, a path or trajectory (e.g., direction of travel, such as toward the site, away from the site, across the site, etc.) of the individual, a location of the individual at the site, proximity to an area (e.g., flower garden, driveway, etc.) of interest or object (e.g., car, bike, package, etc.) of interest at the site, a status of the individual as a returnee to the site, and/or a status of the individual as a resident of a home at the site.

Examples of one or more inferred characteristics of an individual can include, but are not limited to, an intent of the individual (e.g., vandalism, theft, loitering, visiting, delivering, servicing (e.g., shoveling, moving, etc.), etc.) and/or a status of the individual as an intruder or as someone appropriately at the site (e.g., friend, resident). The one or more inferred characteristics of the individual may be determined 406 based on literal characteristics. The literal characteristics and/or the inferred characteristics may be determined utilizing a model, such as a machine learning model, an artificial intelligence model, or the like.

An identifier of a mobile communication device can be detected 410 or otherwise determined. An individual that has been detected may be carrying a mobile communication device. Detecting 410 an identifier of such mobile communication device that is located at the same or a closely similar location as the determined 408 location of the individual can allow for utilizing that mobile communication device for deterrence of the individual. Presently operating and/or available mobile communication systems utilize protocols that include a mobile communication device transmitting (e.g., broadcasting) an identifier to a base station (or node) of a mobile communication network to establish and/or maintain a communicative connection with the mobile communication network. That broadcasted identifier is a unique identifier that indicates to the communication network an identity (and potentially other information) of the mobile communication device that is connected/ing to the communication network. Capturing, intercepting, or otherwise detecting the transmitted identifier can enable sending a signal to the mobile communication device, such as via the mobile communication network. The identifier detected can be any suitable identifier, such as a temporary mobile subscriber identifier (TMSI), a globally unique temporary identifier (GUTI), a subscription concealed identifier (SUCI), a subscription permanent identifier (SUPI), an international mobile subscriber identity (IMSI), and a network access identifier (NAI). The identifier may be temporary, so as to attempt to conceal an actual identity of the individual. In other embodiments, the identifier may be a permanent identifier for the mobile device on the mobile communication network. In some embodiments, the identifier may be a network identifier on a local network. The identifier may be determined through detecting a new (and potentially unknown) device connecting to a network. The identifier provides a way for sending a message or for requesting an associated mobile communication network to send a message to the mobile communication device.

A message can be generated 412 to be provided to the mobile communication device. The message generated 412 can be an electronic message. The electronic message can be a text message, such as a short message system (SMS) text message. The electronic message can include image data such as an image of the detected individual. The electronic message can be generated 412 to contain content based on the one or more characteristics of the individual. The electronic message can be generated 412 to contain content according to the sensor data. The message may be generated 412 to attempt to induce an action from the individual, such as to have a deterrent effect or a welcoming (or greeting) effect. The message may be generated 412 utilizing a model, such as a machine learning model, artificial intelligence model, or the like, and utilizing the characteristics as an input to the model.

The electronic message can be transmitted 414 for delivery to the mobile communication device, according to the identifier. The electronic message and the identifier may be transmitted, for example, to the mobile communication network, which can then use the identifier to locate the mobile communication device and deliver the electronic message to the mobile communication device. The message transmitted to the mobile communication device may be viewed by the detected individual. A message containing information on the individual's characteristics, location and/or whereabouts in relation to a site and timing may more effectively deter or welcome the detected individual. Thus, the method 400 can address shortcomings of existing technology, which can lose effectiveness over time.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments. These features and advantages of the embodiments will become more fully apparent from the following description and appended claims or may be learned by the practice of embodiments as set forth hereinafter.

As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules to emphasize their implementation independence more particularly. For example, a module may be implemented as a hardware circuit comprising custom very large scale integrated (“VLSI”) circuits or gate arrays, off-the-shelf semiconductor circuits such as logic chips, transistors, or other discrete components. A module may also be implemented in programmable hardware devices such as an FPGA, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a server, cloud storage (which may include one or more services in the same or separate locations), a hard disk, a solid state drive (“SSD”), an SD card, a random access memory (“RAM”), a read-only memory (“ROM”), an erasable programmable read-only memory (“EPROM” or Flash memory), a static random access memory (“SRAM”), a Blu-ray disk, a memory stick, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network, a personal area network, a wireless mesh network, and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the C programming language or similar programming languages.

The computer readable program instructions may execute entirely on the user's computer, partly on the user's computer, as a stand-alone software package, partly on the user's computer and partly on a remote computer 125 or service or entirely on the remote computer 125 or server or set of servers. In the latter scenario, the remote computer 125 may be connected to the user's computer through any type of network, including the network types previously listed. Alternatively, the connection may be made to an external computer (for example, through the Internet using an Internet Service Provider). In some embodiments, electronic circuitry including, for example, programmable logic circuitry, FPGA, or programmable logic arrays (“PLA”) may execute the computer readable program instructions by utilizing state information of the computer readable program instructions to personalize the electronic circuitry to perform aspects of the present invention.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and computer program products according to various embodiments of the present invention. In this regard, each block in the schematic flowchart diagrams and/or schematic block diagrams may represent a module, segment, or portion of code, which comprises one or more executable instructions of the program code for implementing the specified logical functions.

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Means for performing the steps described herein, in various embodiments, may include one or more of a network interface, a processor (e.g., a CPU, a processor core, an FPGA or other programmable logic, an ASIC, a controller, a microcontroller, and/or another semiconductor integrated circuit device), an HDMI or other electronic display dongle, a hardware appliance or other hardware device, other logic hardware, and/or other executable code stored on a computer readable storage medium. Other embodiments may include similar or equivalent means for performing the steps described herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus comprising:
one or more processors configured to execute instructions to perform operations to cause the apparatus to:
detect a presence of an individual at a site based on sensor data from one or more sensors positioned at the site;
in response to detecting the presence of the individual at the site, determine one or more characteristics of the individual detected at the site based on the sensor data from the one or more sensors;
determine an identifier of a mobile communication device at a location of the individual detected at the site, according to the sensor data;
generate an electronic message for transmission to the mobile communication device, wherein the electronic message contains content based on the one or more characteristics; and
transmit the electronic message for delivery to the mobile communication device, according to the identifier.

2. The apparatus of claim 1, wherein the message is a personalized message prepared according to one or more of the sensor data and the one or more characteristics of the individual.

3. The apparatus of claim 1, wherein the message is prepared to provide a deterrent effect to motivate the individual to leave the site.

4. The apparatus of claim 1, further comprising a machine learning model that is trained according to reactions of previously detected individuals to different messages, wherein the one or more processors generate the electronic message dynamically using machine learning model, according to one or more of the sensor data and/or one or more characteristics of the individual.

5. The apparatus of claim 1, wherein the sensor data comprises one or more of audio data, image data, and depth data.

6. The apparatus of claim 1, wherein the one or more characteristics of the individual indicate the individual is an intruder at the site.

7. The apparatus of claim 1, wherein the identifier is one of a temporary mobile subscriber identifier (TMSI), a globally unique temporary identifier (GUTI), a subscription concealed identifier (SUCI), a subscription permanent identifier (SUPI), an international mobile subscriber identity (IMSI), and a network access identifier (NAI).

8. The apparatus of claim 1, wherein the mobile communication device comprises a mobile phone, the message is transmitted to the mobile phone via a mobile carrier, and the message comprises an SMS text message.

9. The apparatus of claim 1, wherein the one or more sensors comprises one or more of an audio sensor, an image sensor, and a depth sensor.

10. The apparatus of claim 9, wherein the audio sensor comprises a microphone, the image sensor comprises a camera, and the depth sensor comprises one or more of an infrared sensor, a radar sensor, and a structured light sensor.

11. The apparatus of claim 1, wherein the one or more processors are further to execute instructions to perform operations to compare the identifier to a current list of known identifiers to determine the identifier is a new identifier that arrived to the site with the individual.

12. A building system comprising:
one or more sensors to be positioned at a site of a building and each to capture sensor data relevant to one or more of the building, an environment of the building, the site of the building, an area adjacent to the building; and
one or more processors configured to execute instructions to perform operations to cause the system to:
detect, using sensor data from the one or more sensors, a presence of an individual;
detect, by a sensor of the one or more sensors, an identifier being broadcast by a mobile communication device that is at a location of the individual detected;
generate an electronic message to be sent to the mobile communication device, according to the sensor data; and
transmit the electronic message to the mobile communication device via a mobile communication network associated with the mobile communication device.

13. The building system of claim 12, wherein the sensor data comprises one or more of audio data, image data, and depth data.

14. The building system of claim 12, wherein one or more characteristics of the individual indicate the individual is an intruder at the site.

15. The building system of claim 12, wherein the identifier is one of a temporary mobile subscriber identifier (TMSI), a globally unique temporary identifier (GUTI), a subscription concealed identifier (SUCI), a subscription permanent identifier (SUPI), an international mobile subscriber identity (IMSI), and a network access identifier (NAI).

16. The building system of claim 12, wherein the mobile communication device comprises a mobile phone, the message is transmitted to the mobile phone via a mobile carrier, and the message comprises an SMS text message.

17. A computer-implemented method comprising:
detect a presence of an individual at a site based on sensor data from one or more sensors positioned at the site;
in response to detecting the presence of the individual at the site, determine one or more characteristics of the individual detected at the site based on the sensor data from the one or more sensors;
determine an identifier of a mobile communication device at a location of the individual detected at the site, according to the sensor data;
generate an electronic message for transmission to the mobile communication device, wherein the electronic message contains content based on the one or more characteristics; and
transmit the electronic message for delivery to the mobile communication device, according to the identifier.

18. The method of claim 17, wherein the electronic message is a personalized message prepared according to one or more of the sensor data and the one or more characteristics of the individual.

19. The method of claim 17, wherein the message is prepared to provide a deterrent effect to motivate the individual to leave the site.

20. The method of claim 17, further comprising a machine learning model that is trained according to reactions of previously detected individuals to different messages, wherein the electronic message is dynamically generated using the machine learning model, according to one or more of the sensor data and/or one or more characteristics of the individual.
